(19) United States
(12) Patent Application Publication
(10) Pub. No.: US 2004/0262123 A1
(43) Pub. Date: Dec. 30, 2004

(54) Sorting device for goods to be transported especially in a suspended manner, and method for operating one such sorting device

(76) Inventors: Peter Maximilian Wolfel, Oberottmarshausen (DE); Gerhard Steber, Landsberg (DE)

Correspondence Address: EDWARDS & ANGELL, LLP, P.O. BOX 55874, BOSTON, MA, 02205, US

(21) Appl. No.: 10/491,053

(22) PCT Filed: Oct. 9, 2002
(86) PCT No.: PCT/EP02/11322

(30) Foreign Application Priority Data
Oct. 10, 2001 (DE) 101-49-910.8

(51) Int. Cl. B65G 37/00

(52) U.S. Cl. 198/348

(57) ABSTRACT

A sorting apparatus for conveyable articles which are conveyed, in particular, in a hanging state, for example items of clothing hanging on clothes hangers (10), has a sorting conveying path (14) which can be charged with the conveyable articles at at least one charging station (30, 32) and along which the conveyable articles can be conveyed in a conveying direction on driven running elements, for example individual hanger carriers (12). Branching off from the sorting conveying path (14) are a multiplicity of discharge branches (24), onto which the conveyable articles can be selectively discharged from the sorting conveying path (14) by discharge means. According to the invention, the sorting conveying path (14) is designed as an endless circulating path, the discharge branches (24) being combined into at least two discharge banks (26, 28), which are distributed along this circulating path (14) and between which in each case one charging station (30, 32) is provided.

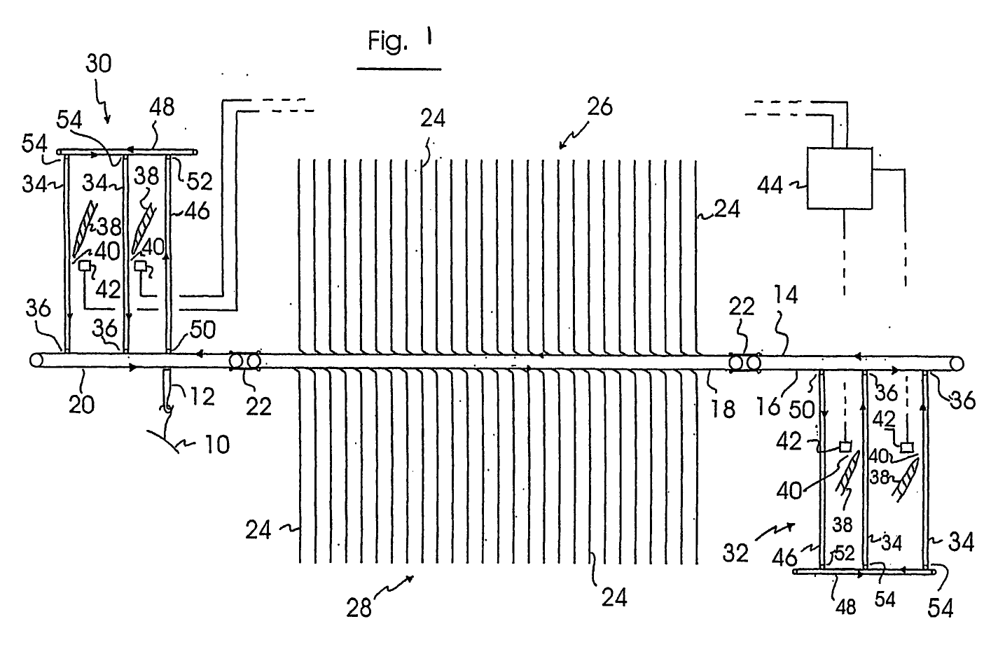

The invention relates to a sorting apparatus for conveyable articles which are conveyed, in particular, in a hanging state, having a sorting conveying path which can be charged with the conveyable articles at at least one charging station and along which the conveyable articles can be conveyed in a conveying direction on driven running elements, and having a multiplicity of discharge branches which branch off from the sorting conveying path and onto which the conveyable articles can be selectively discharged from the sorting conveying path by discharge means.

Such sorting apparatuses are used, for example, for sorting items of clothing hung on clothes hangers. In this case, the items of clothing are passed out onto the various discharge branches, from the sorting conveying path, in accordance with predetermined sorting criteria. For example, it is thus possible to perform order-picking tasks in the case of which batches of items of clothing sorted by size, color, type or the like are put together on the discharge branches in accordance with customer orders, and these batches are then delivered to the relevant customer or customers.

A sorting apparatus of the type referred to in the introduction is known, for example, from DE 39 02 712 C2. A sorting conveying path which terminates in a dead end is provided in the case of this known solution. A plurality of branches, which together form a collecting store, branch off from the sorting conveying path upstream of its dead end. The branches are assigned to different recipients; the items of clothing which are supplied on the sorting conveying path are divided up between the different branches, in dependence on the customer orders which are to be made up, and stored on an interim basis there. As soon as the batches of items of clothing collecting on the branches have reached a desired magnitude, they are transported away.

In the case of sorting apparatuses of the type in question here, a high sorting capacity is generally desired, i.e. the intention is for it to be possible for the largest possible number of conveyable articles to be sorted in the shortest possible amount of time. It has been found in practice that the capacity of the sorting apparatus known from DE 39 02 712 C2 is often no longer sufficient to satisfy the increased requirements on the part of the users of sorting apparatuses.

The invention thus proposes, for a sorting apparatus of the type referred to in the introduction, that the sorting conveying path is designed as a circulating sorting path, and that the discharge branches are combined into at least two discharge banks, which are distributed along the circulating sorting path and between which in each case one charging station is provided.

In the case of the solution according to the invention, the sorting conveying path, rather than being designed as a dead end, forms a circulatory path along which a plurality of discharge banks and a plurality of charging stations can be arranged alternately one after the other. At each of these charging stations, conveyable articles can be supplied onto the circulating sorting path. In particular, it is possible for conveyable articles to be fed into the circulating sorting path simultaneously from different charging stations and to be selected for transfer to the discharge branches of different discharge banks. A sorting apparatus designed in this way makes it possible to achieve a higher throughput of conveyable articles than has been the case hitherto, it being possible to optimize the sorting capacity by a strategically favorable selection of the charging station and of the discharge bank at which a certain article which is to be sorted is fed into the sorting conveying path and passed out onto a discharge branch.

The running elements on which the conveyable articles are transported along the circulating sorting path may be of any desired type. In particular, they may be conveyable-article carriers on which one or more articles which are to be conveyed can be hung. Examples of such conveyable-article carriers are so-called individual hanger carriers, which have a hook on which a carrier hanger hung with the conveyable articles can be hung, or so-called trolleys, which have a carrying bar on which a plurality of such carrier hangers can be hung. Also conceivable as running elements are, for example, so-called conveying pawls, in other words driven carry-along elements by means of which carrier hangers for the conveyable articles, the hangers being hung on a running rail, are carried along the running rail.

In the case of a preferred embodiment of the sorting apparatus according to the invention, the discharge branches are divided up between a total of two discharge banks. Of course, it should expressly be pointed out that, in alternative embodiments, it is also possible to provide more than two discharge banks separated by in each case one charging station. In the case of the sorting apparatus being configured with two discharge banks, a design which has proven to be advantageous is one in which the circulating sorting path is elongate, the discharge banks are arranged on in each case one longitudinal side of the circulating sorting path, in particular located opposite one another essentially centrally, and the charging stations are also arranged on in each case one longitudinal side of the circulating sorting path, in particular in the vicinity of the longitudinal ends thereof. It is possible here for the charging stations to be arranged downstream, as seen in the conveying direction, of the discharge bank arranged on the same longitudinal side of the circulating sorting path in each case.

In the case of a large number of discharge branches per discharge bank and a corresponding length of the circulating sorting path, it may be advantageous, rather than constructing the circulating sorting path from a single conveying circuit, for a plurality of conveying circuits with the same direction of circulation to be arranged one behind the other, adjacent conveying circuits being connected to one another in each case by transfer means which allow transfer of the running elements between the respective conveying circuits.

A preferred development of the sorting apparatus according to the invention provides that each charging station has at least one charging conveying path, which is connected to the circulating sorting path and via which running elements loaded with conveyable articles can be introduced into the circulating sorting path, and that at least some of the charging stations are, in particular each charging station is, assigned in each case at least one return conveying path, which is connected to the circulating sorting path and onto which empty running elements can be discharged from the circulating sorting path. In order to increase the (sorting) capacity of the sorting apparatus further, it is possible for at least some of the charging stations to have a plurality of, but at least two, spaced-apart charging conveying paths, which are connected to the circulating sorting path and via each of which running elements loaded with conveyable articles can be introduced into the circulating sorting path.

Each charging conveying path may be assigned a loading unit by means of which running elements can be loaded with conveyable articles on the relevant charging conveying path. It is preferable here for the loading unit to comprise a screw conveyor for guiding the conveyable articles up to a loading location, at which the running elements can be loaded with the conveyable articles on the respective charging conveying path. Other conveying concepts for guiding the conveyable articles up to the loading location are, of course, not ruled out.

It is particularly advantageous if the return conveying path is connected to each charging conveying path of the relevant charging station via a connecting conveying path, which is separate from the circulating sorting path. Running elements which have been unloaded of conveyable articles beforehand at one of the discharge banks and fed back—in the empty state—to a charging station may thus be immediately redirected at this charging station, via the return conveying path and the connecting conveying path, into a charging conveying path and loaded with further conveyable articles there. Long intervals between usage of the running elements may thus be avoided. This increases the efficiency of the sorting apparatus.

It is recommended that, by way of the discharge means, running elements which are moved to the discharge banks can be unloaded of their conveyable articles on the circulating sorting path and the unloaded conveyable articles can be transferred to the discharge branches. In this way, there is no need for the running elements to be discharged from the circulating sorting path in order to be unloaded, which allows them to be passed on quickly for further usage. This likewise has the effect of increasing efficiency. If the conveyable articles have been hung on carrier hooks, as is the case for example with items of clothing which have been hung on clothes hangers, the discharge branches may be formed, in a straightforward manner, by sliding bars, on which the discharge means can hang the unloaded conveyable articles.

In accordance with a further aspect, the invention also relates to a method of operating a sorting apparatus for conveyable articles which are conveyed, in particular, in a hanging state, it being the case that the sorting apparatus comprises a sorting conveying path which is designed as a continuous circulating sorting path and along which driven running elements loaded with the conveyable articles can be conveyed, that branching off from the circulating sorting path are a multiplicity of discharge branches which are combined into at least two discharge banks distributed along the circulating sorting path, and onto which the conveyable articles can be selectively discharged from the circulating sorting path, and that provided between each pair of adjacent discharge banks is a charging station, at which empty running elements can be loaded with conveyable articles and introduced into the circulating sorting path, and at which running elements which have been unloaded of their conveyable articles on the discharge branches can be discharged from the circulating sorting path.

The invention provides, in the case of this method, that

a) at least some of the running elements are loaded with conveyable articles at a first of the charging stations, and, once introduced into the circulating sorting path and unloaded of their conveyable articles, are discharged from the circulating sorting path at a second of the charging stations, loaded with further conveyable articles there and then re-introduced into the circulating sorting path, and/or

b) at least some of the running elements are loaded with conveyable articles at a first of the charging stations, and, once introduced into the circulating sorting path and unloaded of their conveyable articles, are discharged from the circulating sorting path at a second of the charging stations, stored on an interim basis there, and then re-introduced into the circulating sorting path, moved back to the first charging station and, there, discharged from the circulating sorting path and loaded with further conveyable articles.

An exemplary embodiment of the invention is explained in more detail hereinbelow with reference to the attached single drawing. The latter shows, schematically, a suspension-type conveying installation which is designed for sorting items of clothing (not illustrated specifically) hung on clothes hangers 10, and in which the clothes hangers 10 are conveyed in a state in which they hang on individual hanger carriers 12 serving as runner elements. The individual hanger carriers 12 may be, for example, those which have been described in DE 94 02 990 U1. Of course, instead of such individual hanger carriers, it is also possible to use differently configured runner elements. In particular, it is conceivable to use hanger carriers which can accommodate a plurality of clothes hangers 10 at the same time. An example of such multiple hanger carriers are so-called conveying trolleys, which have a carrying bar on which a plurality of clothes hangers 10 can be hung one beside the other. An exemplary configuration of such conveying trolleys is outlined in DE 39 02 712 C2, which was mentioned in the introduction. Moreover, it goes without saying that the sorting installation according to the invention can also be used for sorting articles other than items of clothing, and that it is possible to use carrier hooks which are configured in a correspondingly different manner to the clothes hangers 10 mentioned. The hanger carriers 12 may be driven in a manner which is known per se, but is not illustrated specifically here, for example by means of drive belts or drive chains.

The sorting installation has a central circulating path 14 along which the hanger carriers 12 can circulate in the direction specified by small arrows. In the case of the example illustrated, this circulating path 14 is constructed from three conveying circuits 16, 18, 20 arranged one behind the other. Merely schematically indicated transfer means 22 between the conveying circuits 16, 18, 20 make it possible for the hanger carriers 12, together with the clothes hangers 10 hanging on them, to be transferred from one of the conveying circuits to the next, to be precise such that they maintain their running direction along the circulating path 14. The reason for constructing the circulating path 14 from a plurality of conveying circuits will be discussed further hereinbelow. Of course, it goes without saying that a solution in which use is made of just a single conveying circuit for forming the circulating path 14 is no way ruled out and is likewise conceivable.

The circulating path 14, as can be seen clearly in the drawing, is of elongate design. Arranged on the two longitudinal sides of the circulating path 14 are a multiplicity of schematically indicated ejecting bars 24, which are connected to the circulating path 14 via ejecting diverters (not illustrated specifically). These ejecting diverters are designed to disengage the clothes hangers 10 from the hanger carriers 12 and to hang them on the ejecting bars 24. The hanger carriers 12 remain on the circulating path 14 here; it is thus merely the clothes hangers which are discharged onto the ejecting bars 24. The latter are preferably designed as obliquely downwardly running sliding bars, on which the clothes hangers 10 which have been ejected can slide down, for example, as far as a stop and can be removed manually at a later stage.

The ejecting bars 24 are combined into two ejecting banks 26, 28, which are arranged essentially centrally on the longitudinal sides of the circulating path 14 and are located opposite one another. In the example illustrated, they have an equal number of ejecting bars 24; however, the situation where they have different numbers of ejecting bars 24 is not ruled out. With a corresponding number of ejecting bars 24, it is possible for the ejecting banks to extend over a comparatively long distance along the circulating path 14. In practice, this distance may readily be tens of meters long, for example approximately 30 meters long. In such a case, this would result in the circulating path 14 having a considerable overall length, for example more than 100 meters. It has been found that common drive concepts for circulating conveying paths may be limited in the case of such long distances. This is why, in the case of the example illustrated, the circulating path 14 is constructed from a plurality of conveying circuits arranged one behind the other.

Along the circulating path 14, charging stations 30, 32 are arranged between the two ejecting banks 26, 28. The two charging stations 30, 32 are arranged on different longitudinal sides of the circulating path 14, in the vicinity of the longitudinal ends thereof, with the result that they are located diametrically opposite one another. Each of the charging stations 30, 32 serves for charging empty hanger carriers 12 with clothes hangers 10 and then for feeding into the circulating path 14 the hanger carriers 12 which are loaded in this way. For this purpose, each charging station 30, 32 has at least one conveying circuit 34, which will be referred to hereinbelow as a charging circuit and, at 36, is connected to the circulating path 14 via a diverter (not illustrated specifically). In order to load the hanger carriers 12, each charging circuit 34 is assigned a loading conveyor 38, which preferably—and as is indicated schematically in the drawing—is designed as a screw conveyor and by means of which items of clothing hanging on clothes hangers 10 are guided up to a loading location 40, where the clothes hangers 10 are transferred individually to the empty hanger carriers 12 of the relevant charging circuit 34. This loading location 40 is assigned sensor-type reading means 42, by way of which identification codes provided on the hanger carriers 12 and on the clothes hangers 10 can be read and transmitted to a central control unit 44. If a hanger carrier 12 is loaded with a clothes hanger 10, then the control unit 44 assigns the identification codes of the relevant hanger carrier 12 and of the relevant clothes hanger 10 to one another; the data of the hanger carrier 12 and of the clothes hanger 10 are, as it were, “married” to one another. As a result of this marriage, it is possible for each item of clothing to be tracked on a continuous basis as it runs through the sorting installation and to be guided to a desired ejecting bar 24.

As has already been mentioned, each charging station 30, 32 has at least one charging circuit 34. In order to increase the capacity of the sorting installation, that is to say in order to make it possible to process more items of clothing per unit of time, it is also possible for the charging stations 30, 32 to have a plurality of charging circuits 34 which are connected successively to the circulating path 14. This case is illustrated in the drawing; here, each charging station 30, 32 is provided with two charging circuits 34. Of course, it is also possible to provide more than two, for example three or four, charging circuits 34 at each charging station 30, 32. It is also the case that the situation where the charging stations 30, 32 have different numbers of charging circuits 34 is not ruled out.

Once the hanger carriers 12 have been loaded with clothes hangers 10 at the charging stations 30, 32 and then discharged onto the circulating path 14, they are transported to the ejecting banks 26, 28, where they are unloaded under the control of the control unit 44. Under control of the control unit 44 here means that the control unit 44 determines, in accordance with criteria which have been fixed beforehand, which ejecting bank 26 or 28 and which ejecting bar 24 a hanger carrier 12 is to be moved to in order to be freed there of its clothes hanger 10. These criteria, in accordance with which the clothes hangers 10 are divided up between the different ejecting bars 24, may be dictated, for example, by customer orders which are to be made up. In this case, different ejecting bars 24 will be assigned to different customers, and the items of clothing will be ejected at the associated ejecting bar or bars 24 in the sequence and/or quantity and/or type desired by the respective customer. The items of clothing which have been ejected can be stored on an interim basis on the ejecting bars 24 and—as soon as they have been put together to form a desired batch—they can be disengaged from the ejecting bars 24 and delivered to the customer.

Once unloaded of the clothes hangers 10, the empty hanger carriers 12 are guided back to the charging stations 30, 32. It would be conceivable, in principle, for it to be possible for the empty hanger carriers 12 to be guided back directly into the charging circuit 34 from the circulating path 14, via the diverters 36, in order to pass them on to be loaded anew. However, this could result in obstructions occurring between the returning empty hanger carriers 12 and newly loaded hanger carriers 12 which are just to be transferred to the circulating path 14. In order to avoid such obstructions, the charging stations 30, 32 preferably have in each case at least one further conveying circuit 46, which is separate from their charging circuits 34 and is referred to hereinbelow as a return circuit. By means of this return circuit 46, which is connected to the circulating path 14 parallel to the charging circuits 34, the hanger carriers 12 which have been unloaded of their clothes hangers 10 are received from the circulating path 14. As can clearly be seen in the drawing, the return circuits are arranged upstream of the charging circuits 34 of the respectively associated charging station 30, 32, as seen in the direction of circulation of the circulating path 14. Empty hanger carriers 12 which run onto one of the charging stations 30, 32 can thus be removed from the circulating path 14 in good time before new, loaded hanger carriers 12 are fed into the circulating path 14. This makes it possible to avoid collisions between returning empty hanger carriers 12 and loaded hanger carriers 12 which are passed out onto the circulating path 14.

In order for it to be possible for the empty hanger carriers 12 which are brought into the return circuits 46 to be loaded anew and thus allowed to take part in the sorting process, each charging station 30, 32 contains a further conveying circuit 48, which will be referred to hereinbelow as a connecting circuit and, remote from the circulating path 14, produces a connection between the return circuit 46 and each charging circuit 34 of the relevant charging station 30 or 32. Via this connecting circuit 48, it is possible for empty hanger carriers 12 to be fed from the return circuit 46 into a desired charging circuit 34 of the relevant charging station 30 or 32 and to be passed on there for renewed loading.

The course of the empty hanger carriers 12 is controlled via diverters (not illustrated specifically) which are arranged at 50, at the location where the circulating path 14 is connected to each return circuit 46, at 52, at the location where each return circuit 46 is connected to the associated connecting circuit 48, and at 54, at the locations where each connecting circuit 48 is connected to the charging circuits 34 connected thereto. All of these diverters 50, 52, 54—just like the diverters 36 and the ejecting diverters assigned to the ejecting bars 24—can be controlled by the control unit 44 in respect of their diverter positioning. As far as the diverters 36, 50, 52, 54 are concerned, the latter can thus be actuated such that it is possible for the hanger carriers 12 optionally to be transferred in both directions between interconnected conveying circuits or to circulate in each of the conveying circuits.

During operation of the sorting installation, it is conceivable for each charging station to serve in each case just the following ejecting bank, as seen in the direction of circulation of the circulating path 14. In the example illustrated, this would mean that the charging station 30 serves just the ejecting bank 28, while the charging station 32 serves solely the ejecting bank 26. Of course, it is also conceivable for both ejecting banks 26, 28 to be served by at least one of the charging stations 30, 32. In this case, at least some of the loaded hanger carriers 12 which are fed into the circulating path 14 at one of the charging stations 30, 32 would run past the first-following ejecting bank and the other charging station before reaching the second-following ejecting bank and being unloaded there.

It has already been mentioned that the empty hanger carriers 12, which have been freed of their load, can be discharged from the circulating path 14 via the return circuits 46. A preferred way of operating the sorting installation, then, may consist in at least some of the hanger carriers 12 being at least temporarily “re-routed”. Re-routing here means that hanger carriers 12 which have been fed into the circulating path 14 at one of the charging stations 30, 32 are selected for transfer to the return circuit 46 of the other charging station. At least some of the hanger carriers 12 which have been re-routed in this way can then be re-loaded with clothes hangers 10 at this other charging station by being fed into one of the charging circuits 34 of the relevant charging station via the connecting circuit 48 of the latter. As an alternative, or in addition, it is possible for at least some of the re-routed hanger carriers 12 to be stored on an interim basis in the return circuit 46 of the other charging station mentioned and for these then to be discharged again onto the circulating path 14, on which they are brought back to the first-mentioned charging station and loaded with clothes hangers 10 again there. In the case of re-routed empty hanger carriers 12 being stored on an interim basis in one of the return circuits 46, it is recommended, in particular, for the empty hanger carriers 12 to be selected for transfer to the circulating path 14 again in groups of a plurality of hanger carriers 12. This groupwise selection for transfer has the advantage that it is possible to keep to a low level delays in the operation procedure which are produced as a result of the fact that, as empty hanger carriers 12 are discharged onto the circulating path 14 from one of the return circuits 46, the operation of discharging loaded hanger carriers 12 from the charging circuits 34 of the relevant charging station has to be interrupted. If there is an insufficient quantity of empty hanger carriers 12 present in the relevant return circuit 46, the control program of the control unit 44 may be set up such that the selection for transfer from the return circuit 46 is not begun until such time as a predetermined minimum number of empty hanger carriers 12 has collected in the return circuit 46.

The operation of re-routing empty hanger carriers 12 which has been explained above allows adaptation to different throughputs at the two charging stations 30, 32 by increased numbers of empty hanger carriers 12 being brought to those charging stations at which—at least temporarily—a larger quantity of items of clothing which are to be sorted is supplied.

It goes without saying that it is also possible, in principle, for hanger carriers 12 which have been emptied of their load to be moved back directly to that charging station at which they were loaded and fed into the circulating path 14, that is to say without being stored on an interim basis at another charging station beforehand.

1. A sorting apparatus for conveyable articles which are conveyed, in particular, in a hanging state, having a sorting conveying path which can be charged with the conveyable articles at at least one charging station and along which the conveyable articles can be conveyed in a conveying direction on driven running elements, and having a multiplicity of discharge branches which branch off from the sorting conveying path and onto which the conveyable articles can be selectively discharged from the sorting conveying path by discharge means, wherein the sorting conveying path is designed as a circulating sorting path, and wherein the discharge branches are combined into at least two discharge banks, which are distributed along the circulating sorting path and between which in each case one charging station is provided.

2. The sorting apparatus as claimed in claim 1, wherein the discharge branches are divided up between a total of two discharge banks.

3. The sorting apparatus as claimed in claim 2, wherein the circulating sorting path is elongate, in that the discharge banks are arranged on in each case one longitudinal side of the circulating sorting path, in particular located opposite one another essentially centrally, and in that the charging stations are also arranged on in each case one longitudinal side of the circulating sorting path, in particular in the vicinity of the longitudinal ends thereof.

4. The sorting apparatus as claimed in claim 3, wherein the charging stations are arranged downstream, as seen in the conveying direction, of the discharge bank arranged on the same longitudinal side of the circulating sorting path in each case.

5. The sorting apparatus as claimed in claim 1, wherein in order to form the circulating sorting path, a plurality of conveying circuits with the same direction of circulation are arranged one behind the other, adjacent conveying circuits being connected to one another in each case by transfer means which allow transfer of the running elements between the respective conveying circuits.

6. The sorting apparatus as claimed in claim 1, wherein each charging station has at least one charging conveying path, which is connected to the circulating sorting path and via which running elements loaded with conveyable articles can be introduced into the circulating sorting path, and wherein at least some of the charging stations are, in particular each charging station is, assigned in each case at least one return conveying path, which is connected to the circulating sorting path and onto which empty running elements can be discharged from the circulating sorting path.

7. The sorting apparatus as claimed in claim 6, wherein at least some of the charging stations have a plurality of, but at least two, spaced-apart charging conveying paths, which are connected to the circulating sorting path and via each of which running elements loaded with conveyable articles can be introduced into the circulating sorting path.

8. The sorting apparatus as claimed in claim 6, wherein each charging conveying path is assigned a loading unit, by means of which running elements can be loaded with conveyable articles on the relevant charging conveying path.

9. The sorting apparatus as claimed in claim 8, wherein the loading unit comprises a screw conveyor for guiding the conveyable articles up to a loading location, at which the running elements can be loaded with the conveyable articles on the respective charging conveying path.

10. The sorting apparatus as claimed in claim 8, wherein the return conveying path is connected to each charging conveying path of the relevant charging station via a connecting conveying path, which is separate from the circulating sorting path.

11. The sorting apparatus as claimed in claim 1, wherein by way of the discharge means, running elements which are moved to the discharge banks can be unloaded of their conveyable articles on the circulating sorting path and the unloaded conveyable articles can be transferred to the discharge branches.

12. The sorting apparatus as claimed in claim 11, wherein the conveyable articles are hung on carrier hooks, and wherein the discharge branches are formed by sliding bars, and wherein the discharge means are designed in order for conveyable articles which are unloaded from the running elements to be hung on the sliding bars by way of their carrier hooks.

13. A method of operating a sorting apparatus for conveyable articles which are conveyed, in particular, in a hanging state, it being the case that the sorting apparatus comprises a sorting conveying path which is designed as a continuous circulating sorting path and along which driven running elements which are loaded with the conveyable articles can be conveyed, that branching off from the circulating sorting path are a multiplicity of discharge branches which are combined into at least two discharge banks distributed along the circulating sorting path, and onto which the conveyable articles can be selectively discharged from the circulating sorting path, and that provided between pairs of adjacent discharge banks is a charging station, at which empty running elements can be loaded with conveyable articles and introduced into the circulating sorting path, and at which running elements which have been unloaded of their conveyable articles on the discharge branches can be discharged out of the circulating sorting path, and wherein in the case of the method,
a) at least some of the running elements are loaded with conveyable articles at a first of the charging stations, and, once introduced into the circulating sorting path and unloaded of their conveyable articles, are discharged from the circulating sorting path at a second of the charging stations, loaded with further conveyable articles there and then re-introduced into the circulating sorting path.

14. A method of operating a sorting apparatus for conveyable articles which are conveyed, in particular, in a hanging state, it being the case that the sorting apparatus comprises a sorting conveying path which is designed as a continuous circulating sorting path and along which driven running elements which are loaded with the conveyable articles can be conveyed, that branching off from the circulating sorting path are a multiplicity of discharge branches which are combined into at least two discharge banks distributed along the circulating sorting path, and onto which the conveyable articles can be selectively discharged from the circulating sorting path, and that provided between pairs of adjacent discharge banks is a charging station, at which empty running elements can be loaded with conveyable articles and introduced into the circulating sorting path, and at which running elements which have been unloaded of their conveyable articles on the discharge branches can be discharged out of the circulating sorting path, and wherein in the case of the method,
a) at least some of the running elements are loaded with conveyable articles at a first of the charging stations, and, once introduced into the circulating sorting path and unloaded of their conveyable articles, are discharged from the circulating sorting path at a second of the charging stations, stored on an interim basis there, and then re-introduced into the circulating sorting path, moved back to the first charging station and, there, discharged from the circulating sorting path and loaded with further conveyable articles.
